(19) United States
(12) Patent Application Publication
(10) Pub. No.: US 2010/0296300 A1
(43) Pub. Date: Nov. 25, 2010

(54) LED lamp

(76) Inventor: Ho-Hsin Chiu, Hsinchu City (TW)

Correspondence Address: BACON & THOMAS, PLLC, 625 SLATERS LANE, FOURTH FLOOR, ALEXANDRIA, VA, 22314-1176, US

(21) Appl. No.: 12/453,707

(22) Filed: May 20, 2009

(51) Int. Cl. F21S 13/10

(52) U.S. Cl. 362/363

(57) ABSTRACT

An LED lamp includes a glass electric light bulb (1) including a rear hollow projection (2) open to a rear end, the projection (2) having outer threads (6); a socket (4) including front inner threads (7) and two conductors (9) having rear ends connected to a pair of electric wires (8); a conductive mounting member (3) fastened in a front portion of the socket (4) and electrically connected to the conductors (9); and an LED (5) having two legs (51) inserted into the conductive mounting member (3) to fasten them together wherein the fastened LED (5) is electrically connected to the conductive mounting member (3). The bulb (1) is secured to the socket (4) by threadedly securing the outer threads (6) to the inner threads (7).

### BACKGROUND OF THE INVENTION

1. Field of Invention

The invention relates to electric light bulbs and more particularly to an LED (light-emitting diode) lamp with improved characteristics including reduced assembly time and increased reliability in use.

2. Description of Related Art

LEDs are renowned for their long life and their ability to resist shock. Also, an LED consumes much less electrical power than fluorescent lamps (i.e., energy saving). Therefore, LED lighting devices are gaining popularity worldwide.

There have been numerous suggestions in prior patents for LED lamp. For example, U.S. Pat. No. 5,414,605 discloses a lamp assembly, U.S. Pat. No. 5,499,174 discloses a decorative lamp assembly, and U.S. Pat. No. 5,517,394 discloses a decorative lamp assembly. However, the structure of each of above patents is complicated. Further, the prior lamps are expensive to manufacture, trouble-prone, and unreliable in use.

In addition, U.S. Pat. No. 7,086,767 discloses a thermally efficient LED bulb. Thus, continuing improvements in the exploitation of LED lamp are constantly being sought.

### SUMMARY OF THE INVENTION

It is therefore one object of the invention to provide an LED lamp having the advantages of reduced assembly time and increased reliability in use.

To achieve the above and other objects, the invention provides an LED lamp comprising an electric light bulb formed of glass, the bulb including a rear hollow projection open to a rear end, the projection having outer threads; a socket including front inner threads and two conductors having rear ends connected to a pair of electric wires; a conductive mounting member fastened in a front portion of the socket and electrically connected to the conductors; and an LED having two legs inserted into the conductive mounting member to fasten them together wherein the fastened LED is electrically connected to the conductive mounting member, wherein the bulb is secured to the socket by threadedly securing the outer threads to the inner threads.

The above and other objects, features and advantages of the invention will become apparent from the following detailed description taken with the accompanying drawings.

### BRIEF DESCRIPTION OF THE DRAWINGS

FIG. 1 is a longitudinal sectional view of bulb of an LED lamp according to the invention;

FIG. 2 is a longitudinal sectional view of the components of the LED lamp to be assembled;

FIG. 3 is a longitudinal sectional view of the assembled LED lamp; and

FIG. 4 is a longitudinal sectional view of an LED lamp mounted with a spherical bulb different from the bulbous one shown in FIGS. 1 to 3.

### DETAILED DESCRIPTION OF THE INVENTION

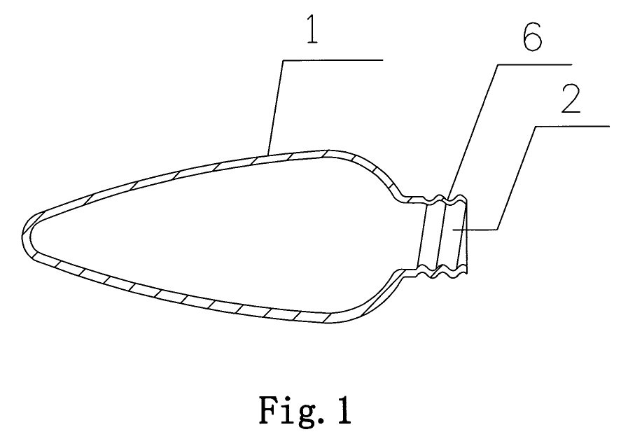

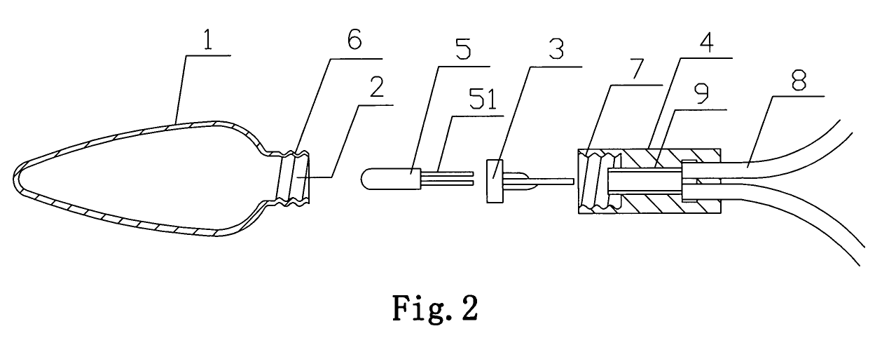

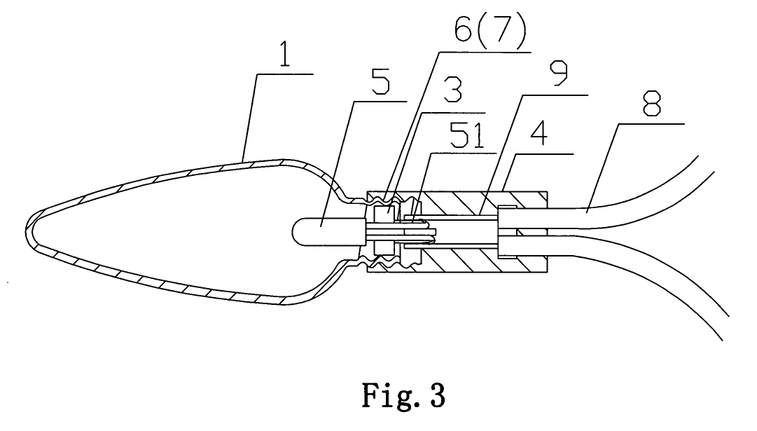

Referring to FIGS. 1 to 3, an LED lamp in accordance with the invention comprises the following components as discussed in detail below.

A bulbous electric light bulb 1 is made of glass. The bulb 1 has a hollow projection 2 open to a rear. Threads 6 are formed on an outer surface of the projection 2. A socket 4 has inner threads 7 formed on its front portion. A pair of electric wires 8 is extended out of a rear end of the socket 4. A conductive mounting member 3 is fastened in the front portion of the socket 4 by snapping. The fastened conductive mounting member 3 is electrically connected to the electric wires 8 via two conductors 9. An LED 5 has two extending legs 51 adapted to insert into the conductive mounting member 3 to secure them together by snapping. The fastened LED 5 is also electrically connected to the conductive mounting member 3. The bulb 1 is secured to the socket 4 by threadedly securing the outer threads 6 to the inner threads 7. This also completes the assembly of the LED lamp. It is envisaged by the invention that benefits such as reduced assembly time and increased reliability in use can be obtained.

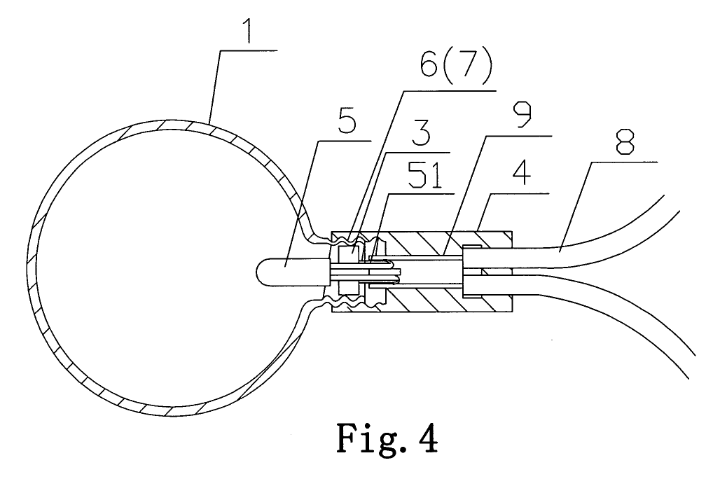

Referring to FIG. 4, the bulbous bulb 1 in FIGS. 1 to 3 is replaced with a spherical bulb 1.

While the invention herein disclosed has been described by means of specific embodiments, numerous modifications and variations could be made thereto by those skilled in the art without departing from the scope and spirit of the invention set forth in the claims.

What is claimed is:

1. An LED lamp comprising:
an electric light bulb (1) formed of glass, the bulb (1) including a rear hollow projection (2) open to a rear end, the projection (2) having outer threads (6);
a socket (4) including front inner threads (7) and two conductors (9) having rear ends connected to a pair of electric wires (8);
a conductive mounting member (3) fastened in a front portion of the socket (4) and electrically connected to the conductors (9); and
an LED (5) having two legs (51) inserted into the conductive mounting member (3) to fasten them together wherein the fastened LED (5) is electrically connected to the conductive mounting member (3),
wherein the bulb (1) is secured to the socket (4) by threadedly securing the outer threads (6) to the inner threads (7).
